(19) United States
(12) Patent Application Publication
(10) Pub. No.: US 2013/0155518 A1
(43) Pub. Date: Jun. 20, 2013

(54) IMAGE DISPLAY

(71) Applicant: ENSKY CO., LTD., Saitama (JP)

(72) Inventor: Koichi Someya, Saitama (JP)

(73) Assignee: ENSKY CO., LTD., Saitama (JP)

(21) Appl. No.: 13/671,383

(22) Filed: Nov. 7, 2012

(30) Foreign Application Priority Data
Nov. 9, 2011 (JP) 006611/2011

(51) Int. Cl. G02B 3/00

(52) U.S. Cl. CPC G02B 3/005
USPC 359/619

(57) ABSTRACT

An image display device of this invention includes an image sheet holding unit, a lens unit, and fixing pins. The lens unit includes a lenticular lens. The lens unit is overlaid on the image sheet holding unit such that an image sheet is sandwiched between the image sheet holding unit and the lens unit. The fixing pins are inserted into the units in this state. The fixing pins can switch between a temporarily fixed state and a fastened state. The temporarily fixed state is a state in which the lens unit can move in a direction along an image printed surface relative to the image sheet holding unit. The fastened state is a state in which the above-described movement is prevented, and the image sheet is pressed and sandwiches between the units. This invention enables to correctly view an image through the lenticular lens without any influence of manufacturing tolerances.

This application is based upon and claims the benefit of priority from the prior Japanese Utility Model Application No. 2011-006611, filed on Nov. 9, 2011, the entire contents of which are incorporated herein by reference.

### BACKGROUND OF THE INVENTION

The present invention relates to an image display device including a lenticular lens.

As an image display device related to the present invention, there exists an image display device disclosed in Japanese Patent Laid-Open No. 2003-344807.

This image display device employs a structure that sandwiches an image sheet between the display device main body and a lenticular lens. The image sheet has an image to be viewed through the lenticular lens, and is made of a paper or plastic film.

When viewing the image through the lenticular lens, it is necessary to accurately align a number of convex lenses included in the lenticular lens and having a semicircular sectional shape with a number of divided images divisionally formed so as to be viewed through the lenticular lens.

In this image display device, the convex lenses and the divided images are aligned by extending a plurality of alignment pins through the lenticular lens and the image sheet. That is, the plurality of alignment pins are provided to stand on the display device main body, and a plurality of through holes are formed in the lenticular lens and the image sheet in advance.

In the above-described image display device, however, the image viewed through the lenticular lens may have an insufficient depth, or may look unnaturally distorted. This is because the positions and thicknesses of the alignment pins, the positions and hole diameters of the through holes, and the like always have tolerances, and it is difficult to eliminate the manufacturing errors. The above-described image display device cannot perform correction to allow the user to correctly view the image.

### SUMMARY OF THE INVENTION

The present invention has been made to solve the above-described problem, and has as its object to provide an image display device that allows to always correctly view an image through a lenticular lens without any influence of tolerances at the time of manufacturing.

In order to achieve the above-described object, according to the present invention, there is provided an image display device comprising an image sheet holding unit that holds an image sheet including an image printed surface on which an image is printed in a state in which the image printed surface is located on an obverse surface side, a lens unit that includes a lenticular lens facing the image printed surface of the image sheet and is overlaid on the image sheet holding unit in a state in which the image sheet is sandwiched between the image sheet holding unit and the lens unit, and a fixing pin that extends through the image sheet holding unit and the lens unit in a state in which the lens unit is overlaid on the image sheet holding unit, wherein the fixing pin is formed to be able to switch between a temporarily fixed state in which the lens unit can move in a direction along the image printed surface relative to the image sheet holding unit and a fastened state in which movement of the lens unit relative to the image sheet holding unit is prevented, and the image sheet is pressed and sandwiched between the lens unit and the image sheet holding unit.

### BRIEF DESCRIPTION OF THE DRAWINGS

FIG. 1 is a front view of an image display device according to an embodiment of the present invention in which a lens unit and an image sheet are partially omitted;

FIG. 2 is a front view of the lens unit;

FIG. 3 is a front view of an image sheet holding unit;

FIG. 4 is a rear view of the image sheet holding unit;

FIG. 5A is an enlarged rear view showing an engaging portion in which a fixing pin is cut away;

FIG. 5B is a sectional view showing the arrangement of the engaging portion;

FIG. 6 is a partially enlarged sectional view of the image display device taken along a line VI-VI in FIG. 1;

FIG. 7 is a partially enlarged perspective view showing the obverse side of the image sheet holding unit;

FIG. 8 is a partially enlarged perspective view showing the reverse side of the image sheet holding unit;

FIG. 9 is a front view of the fixing pin;

FIG. 10 is a side view of the fixing pin;

FIG. 11 is a perspective view of the fixing pin;

FIG. 12 is a side view of a stand;

FIG. 13 is a perspective view of the stand;

FIG. 14 is a front view of part of the image display device when aligning the lens unit with an image;

FIG. 15 is a front view of part of the image display device in a state in which the fixing pin is rotated to the fastening position;

FIG. 16 is a perspective view showing a state in which the image display device is placed upright using the stands in a first support state;

FIG. 17 is a perspective view showing a state in which the image display device is placed upright using the stands in the first support state;

FIG. 18 is a perspective view showing a state in which the image display device is placed upright using the stands in a second support state; and

FIG. 19 is a perspective view showing a state in which the image display device is placed upright using the stands in the second support state.

### DESCRIPTION OF THE PREFERRED EMBODIMENTS

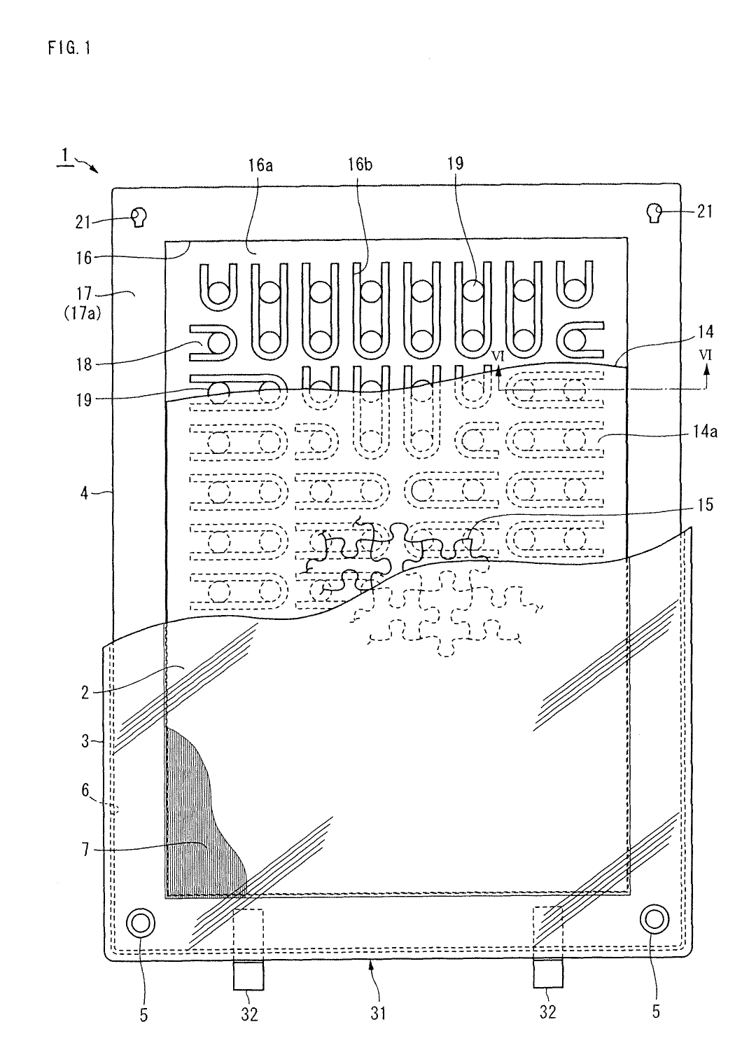

An image display device according to an embodiment of the present invention will now be described in detail with reference to FIGS. 1 to 19. In this embodiment, the obverse side (front surface side) of the image display device will be referred to as a front side or a front portion, and the reverse side will be referred to as a rear side or a rear portion. The direction in which the front side and the read side are connected will be referred to as a forward/backward direction.

An image display device 1 shown in FIG. 1 includes an image sheet holding unit 4 that holds an image sheet 14, a lens unit 3 including a lenticular lens 2, and a plurality of fixing pins 5 used to fix the lens unit 3 to the image sheet holding unit 4.

The lens unit 3 is made of a transparent plastic material into a rectangular shape when viewed from the front side. The lenticular lens 2 having a rectangular shape when viewed from the front side is provided at the center of the lens unit 3. A thin strip-shaped frame 6 extending rearward from the lenticular lens 2 is integrally formed on the outer edge of the lens unit 3. The frame 6 is provided in series all along the outer edge of the lens unit 3 unintermittently. The rectangular opening portion formed by the frame 6 has a size to loosely receive the image sheet holding unit 4.

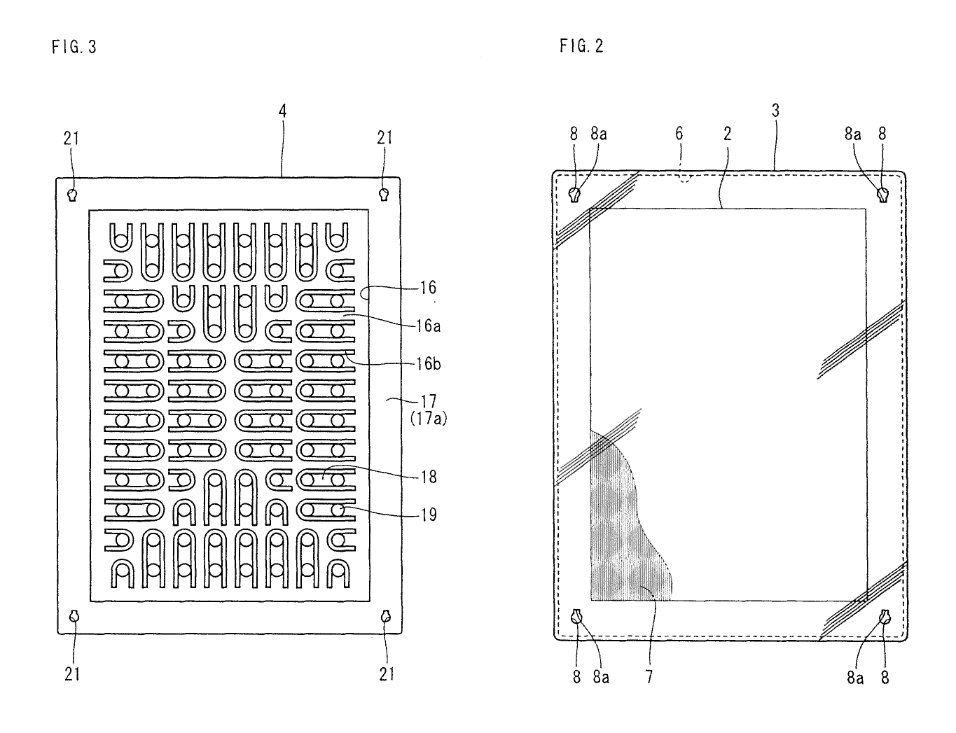

As is well known, the lenticular lens 2 has a structure formed by parallelly arraying a number of (a plurality of) convex lenses 7 (see FIGS. 1 and 2) each having a semicircular sectional shape. The convex lenses 7 extend in the longitudinal direction (vertical direction) in FIG. 2 and are arrayed in the lateral direction (horizontal direction) in FIG. 2.

First through holes 8 for receiving the fixing pins 5 are formed at portions corresponding to the four corners of the lens unit 3, as shown in FIG. 2. Each first through hole 8 has a notch 8a serving as a guide when inserting the fixing pin 5. The notch 8a is formed such that the opening portion of the first through hole 8 extends toward the center of the lens unit 3 in the longitudinal direction.

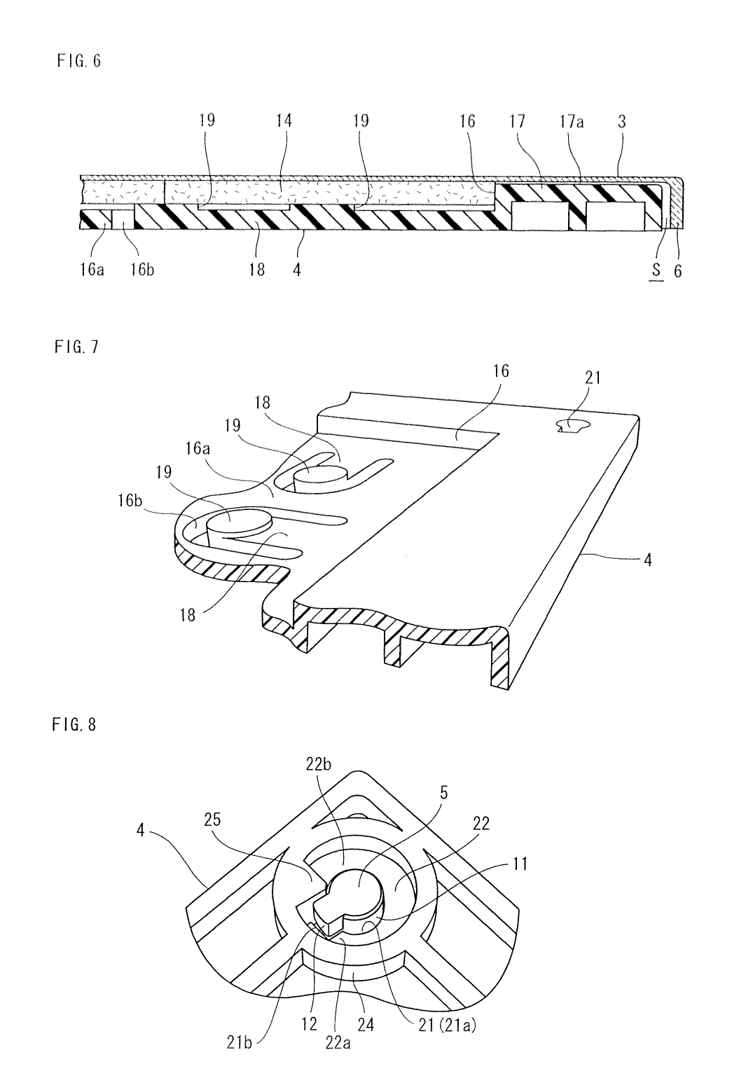

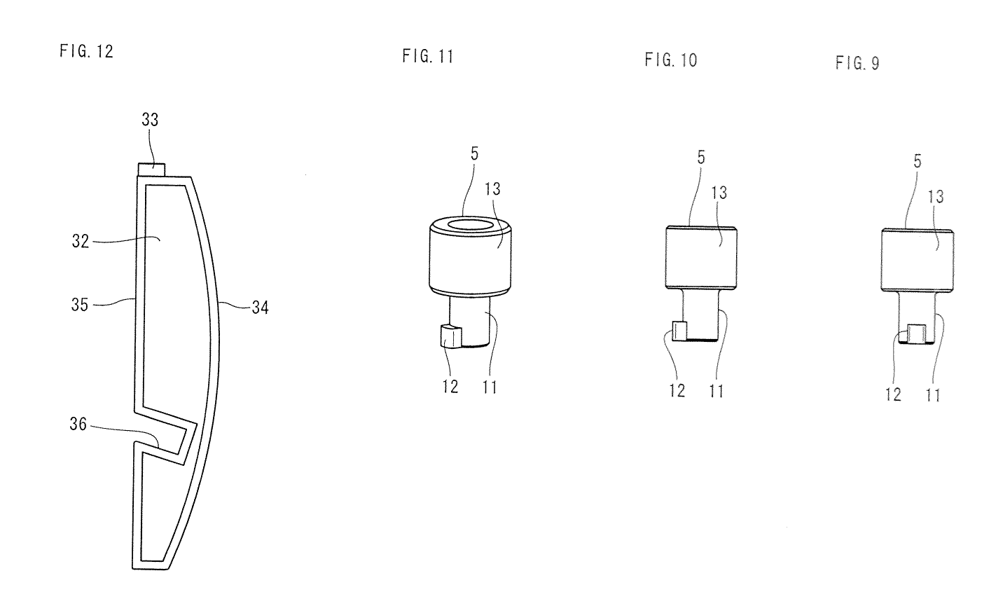

As shown in FIGS. 9 to 11, the fixing pin includes a shaft portion 11, a projecting portion 12 provided at one end of the shaft portion 11 to project in a direction perpendicular to the axial direction, and a knob portion 13 provided at the other end of the shaft portion 11. The shaft portion 11 is formed into a cylindrical shape. The axial length of the shaft portion 11 is decided such that the shaft portion 11 extends through the lens unit 3 and the image sheet holding unit 4, and the projecting portion 12 is located on the reverse side of the image sheet holding unit 4. The projecting portion 12 is formed into a quadrangular prism shape. The knob portion 13 is formed into a cylindrical shape that has a closed bottom and a diameter larger than that of the shaft portion 11. Each through hole 8 of the lens unit 3 is formed into a size capable of receiving the shaft portion 11 and the projecting portion 12 but not the knob portion 13. As shown in FIGS. 1 and 6, the image sheet 14 is sandwiched between the lens unit 3 and the image sheet holding unit 4. The image sheet 14 is a jigsaw puzzle formed by printing, on a number of pieces 15 (see FIG. 1), a stereoscopic image (not shown) that looks stereoscopically through the lenticular lens 2. The image display device 1 overlays the lenticular lens 2 on the image sheet 14 to stereoscopically show the stereoscopic image.

As the image sheet 14, not only the image sheet on which one type of stereoscopic image is printed but also an image sheet (to be simply referred to as a “swing-type image sheet” hereinafter) that shows different patterns by changing the angle of view through the lenticular lens 2 is usable. The swing-type image sheet alternately displays two patterns upon changing the angle of view, or displays a moving image (animation or motion) that continuously changes the pattern. Note that the image of the image sheet 14 is divided in the direction in which the convex lenses 7 of the lenticular lens 2 are arrayed. In this embodiment, the image sheet 14 is formed into the same rectangular shape as that of the lenticular lens 2 when viewed from the front side, as shown in FIG. 1, and fitted in a concave portion 16 (to be described later) of the image sheet holding unit 4.

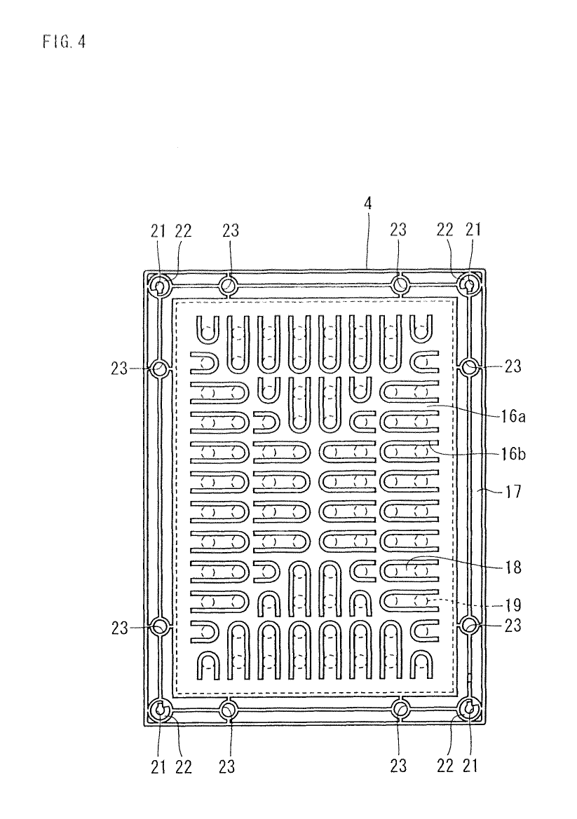

As shown in FIGS. 3 and 4, the image sheet holding unit 4 is formed into a rectangular shape when viewed from the front side. The image sheet holding unit 4 includes the concave portion 16 located at the center, and a frame portion 17 located around the concave portion 16. The outer dimensions (vertical length and horizontal length) of the image sheet holding unit 4 are decided such that the image sheet holding unit 4 can loosely fit inside the frame 6 of the lens unit 3. As shown in FIG. 6, an adjusting gap S of a predetermined size is formed between the image sheet holding unit 4 and the frame 6.

The concave portion 16 is formed into a shape to fit on the image sheet 14. The depth of the concave portion 16 is decided such that the surface (image printed, surface 14a on which the image is printed) of the image sheet 14 fitted in the concave portion 16 projects slightly from a surface 17a of the frame portion 17. When fitted in the concave portion 16, the image sheet 14 is held by the image sheet holding unit 4 while locating the image printed surface 14a on the obverse side of the image sheet holding unit 4.

As shown in FIGS. 3, 4, 6, and 7, the bottom portion of the concave portion 16 is provided with a number of (a plurality of) spring pieces 18. Each spring piece 18 is a cantilever spring having one end connected to the bottom portion and the other end formed as a free end. In this embodiment, the spring pieces 18 are integrally formed on the bottom portion of the concave portion 16 by a forming die (not shown) to form the image sheet holding unit 4. Each spring piece 18 is a portion that forms part of the bottom surface 16a of the concave portion 16 and remains in a U-shaped hole 16b formed in the bottom surface 16a.

As shown in FIGS. 6 and 7, a plurality of projections 19 projecting from the bottom surface of the concave portion. 16 into the concave portion. 16 are provided on the plurality of spring pieces 18 on the obverse surface side of the image sheet holding unit 4. As shown in FIG. 3, each projection 19 has a circular shape when viewed from the front side.

The projections 19 are in contact with the reverse surface of the image sheet 14 fitted in the concave portion 16. The image sheet 14 fitted in the concave portion 16 projects from the surface of the image sheet holding unit 4. Hence, when the lens unit 3 is overlaid on the image sheet holding unit 4 and pressed against the image sheet holding unit 4, the projections 19 are pressed to the reverse surface side. This elastically deforms the spring pieces 18 such that the free ends displace to the reverse surface side (see FIG. 6). As a result, in a state in which the lens unit 3 is pressed against the image sheet holding unit 4, the image sheet 14 is pressed against the reverse surface of the lens unit 3 by the spring force of the spring pieces 18.

As shown in FIG. 1, the projections 19 are arranged at positions facing the four corners of each of the plurality of pieces 15 that constitute the jigsaw puzzle. More specifically, the projections 19 are arranged at positions corresponding to the boundaries to the four adjacent pieces 15. Note that providing at least one projection 19 in correspondence with each piece 15 suffices.

As shown in FIGS. 3 and 4, the frame portion 17 of the image sheet holding unit 4 is provided with second through holes 21 for receiving the fixing pins 5, engaging portions 22 (see FIGS. 4, 5, and 8) with which the fixing pins 5 engage, stand attachment holes 23 (see FIG. 4), and the like.

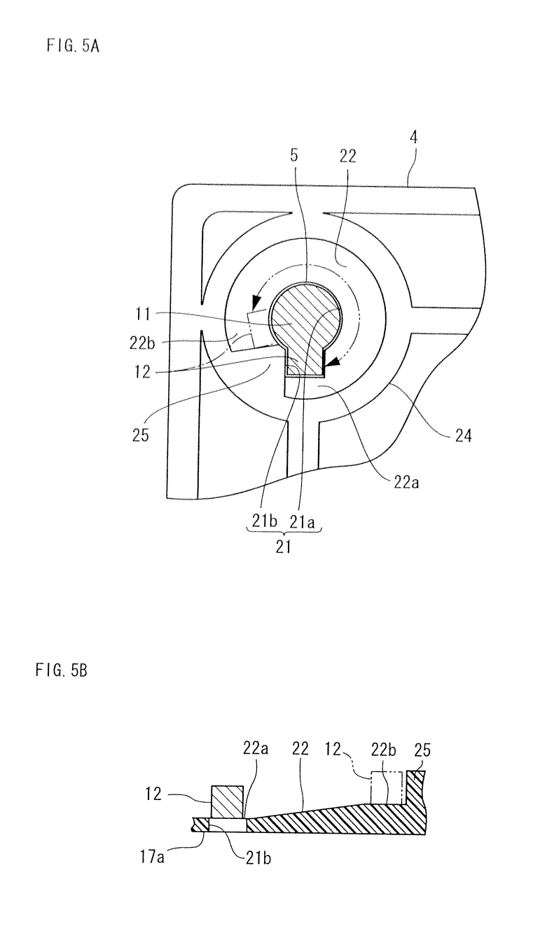

The through holes 21 are formed at the four corners of the image sheet holding unit 4 having a rectangular shape when viewed from the front side at positions overlapping the through holes 8 of the lens unit 3 when viewed from the front side. Each through hole 21 includes a circular portion 21a (see FIG. 5A) for receiving the shaft portion 11 of the fixing pin 5 and a rectangular portion 21b for receiving the projecting portion 12.

The rectangular portion 21b is formed to extend from the circular portion 21a toward the center of the image sheet holding unit 4 in the longitudinal direction. Hence, when inserting the fixing pin 5 into the through hole 8 of the lens unit 3, the projecting portion 12 is aligned with the notch 8a and thus inserted into the rectangular portion 21b. When fixing the lens unit 3 to the image sheet holding unit 4, the fixing pin 5 is inserted into the through holes 8 and 21 from the side of the lens unit 3 and rotated about the shaft portion 11 in a state in which the shaft portion 11 extends through the through holes 8 and 21, and the projecting portion 12 is located on the reverse surface side of the image sheet holding unit 4. The operation of rotating the fixing pin 5 in this way will be referred to as a fastening operation hereinafter.

The engaging portion 22 is used to fasten in cooperation with the fixing pin 5 that has undergone the above-described fastening operation so that the lens unit 3 and the image sheet holding unit 4 cannot move relative to each other. The engaging portion 22 is formed to come into contact with the projecting portion 12 of the fixing pin 5 rotated by the fastening operation. In this embodiment, as shown in FIGS. 5A and 8, the engaging portion 22 is provided inside a tubular wall 24 formed around the through hole 21 on the reverse surface of the image sheet holding unit 4, and extends into a C shape when viewed from the rear side along the moving path of the projecting portion 12 that moves as the fixing pin 5 rotates.

The tubular wall 24 is provided with a projection 25 that abuts against the projecting portion 12 and blocks the rotation of the fixing pin 5. That is, the engaging portion 22 is formed to extend from one end 22a adjacent to the rectangular portion 21b up to the other end 22b adjacent to the projection 25 of the tubular wall 24. In this embodiment, the one end 22a of the engaging portion 22 is defined as a temporary fixing position, and the at end 22b is defined as a fastening position. The fixing pin 5 can rotate from the initial position where the projecting portion 12 is inserted into the rectangular portion 21b to the fastening position where the projecting portion 12 abuts against the project on 25 via the temporary fixing position. In this embodiment, at the time of the fastening operation, the fixing pin 5 makes about ¾ revolution counterclockwise from the initial position in FIG. 5A and then stops at the fastening position.

The engaging portion 22 tilts so as to be gradually located to the rear side of the image sheet holding unit 4 as the angle of rotation of the fixing pin 5 from the initial position increases. In other words, the engaging portion 22 is formed into a spiral shape that is gradually located to the rear side as the above-described angle increases.

Hence, the interval between the obverse surface (the surface 17a of the frame portion 17) and the reverse surface of the image sheet holding unit 4 at the other end 22b (fastening position) of the engaging portion 22 is larger than that at the one end 22a (temporary fixing position), as shown in FIG. 5B. In other words, the thickness of the image sheet holding unit 4 at the fastening position of the engaging portion 22 is larger than that at the temporary fixing position of the engaging portion 22. The interval between the knob portion 13 and the projecting portion 12 via the shaft portion 11 equals the sum of the thickness of the lens unit 3 and that of the image sheet holding unit 4 at the fastening position of the engaging portion 22.

FIG. 5B illustrates the linearly developed state of the engaging portion 22 that spirally tilts. The tilt angle of the engaging portion 22 shown in FIG. 5B is exaggerated to an angle larger than the actual one so as to help understanding the structure.

Note that the structure of the engaging portion 22 is not limited to the spiral structure shown in this embodiment. The engaging portion 22 may have a structure in which, for example, the one end 22a and the other end 22b are formed flat and connected by a tilting surface.

When the fixing pin 5 is rotated from the initial position to the temporary fixing position, the projecting portion 12 comes into contact with the temporary fixing position of the engaging portion 22, and the fixing pin 5 is set in a temporarily fixed state. The temporarily fixed state is a state in which the lens unit 3 can move in a direction along the image printed surface 14a (direction parallel to the image printed surface 14a) with respect to the image sheet holding unit 4. When the fixing pin 5 is further rotated to the fastening position, the projecting portion 12 comes into contact with the fastening position of the engaging portion 22, and the fixing pin 5 is set in a fastened state in which the lens unit 3 and the image sheet holding unit 4 are sandwiched between the projecting portion 12 and the knob portion 13. The fastened state is a state in which the movement of the lens unit 3 relative to the image sheet holding unit 4 is prevented, and the image sheet 14 is pressed and sandwiched between the lens unit 3 and the image sheet holding unit 4. The fixing pin 5 can switch between the temporarily fixed state and the fastened state when rotated between the initial position and the fastening position, as described above.

The temporary fixing position of the engaging portion 22 need not always be immediately adjacent to the initial position. For example, the temporary fixing position may be set to a position rotated about 90° counterclockwise from the initial position in FIG. 5A. In this case, the one end 22a of the engaging portion 22 may be regarded as a region having a predetermined angular range from the initial position.

As shown in FIGS. 1, 12, and 13, the image display device 1 further includes stands 32 attachable to and detachable from an assembly 31 formed by assembling the lens unit 3 and the image sheet holding unit 4. The above-described stand attachment holes 23 of the image sheet holding unit 4 are used to attach the stands 32 to the assembly 31. As shown in FIG. 4, the attachment holes 23 are provided on the reverse side of the image sheet holding unit 4 such that two attachment holes 23 are provided on each side of the image sheet holding unit 4 having a rectangular shape when viewed from the rear side. In this embodiment, the stands 32 are attached to two portions of the lower end of the assembly 31 and support the assembly 31 upright such that the lens unit 3 is directed forward.

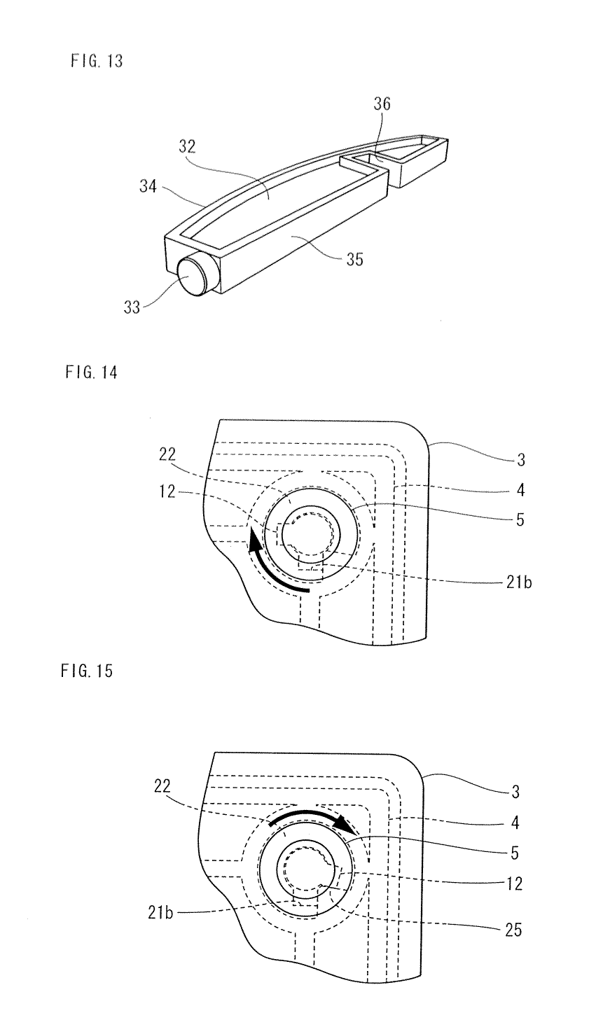

As shown in FIGS. 12 and 13, the stand 32 is formed into a long plate shape. A columnar projection 33 that attachably and detachably fits in the attachment hole 23 is provided at one end of the stand 32 in the longitudinal direction. One side surface extending in the longitudinal direction of the stand 32 forms a convex surface 34 having an arc extending in the longitudinal direction. The other side surface located on the side opposite to the one side surface includes a flat surface 35 extending in the longitudinal direction and a notch 36 formed in the flat surface 35. The notch 36 has a shape in which the assembly 31 attachably and detachably fits. The notch 36 tilts by a predetermined angle with respect to the flat surface 35 and is provided at a position close to the longitudinal end of the stand 32. In this embodiment, the notch 36 is located on the side opposite to the projection 33.

When the projection 33 is fitted in the stand attachment hole 23 while locating the flat surface 35 on the lower side, the stand 32 supports the assembly 31 such that the angle of the assembly 31 viewed from a side is kept constant. In this case, the stands 32 are attached to the two stand attachment holes 23 located on the lower side of the assembly 31. In this embodiment, the other side surface of the stand 32 having the flat surface 35 constitutes a “first placement unit”.

When the lower end of the assembly 31 is fitted in the notch 36, the stand 32 supports the assembly 31 swingably in the forward/backward direction. In this embodiment, one side surface of the stand 32 having the convex surface 34 constitutes a “second placement unit”.

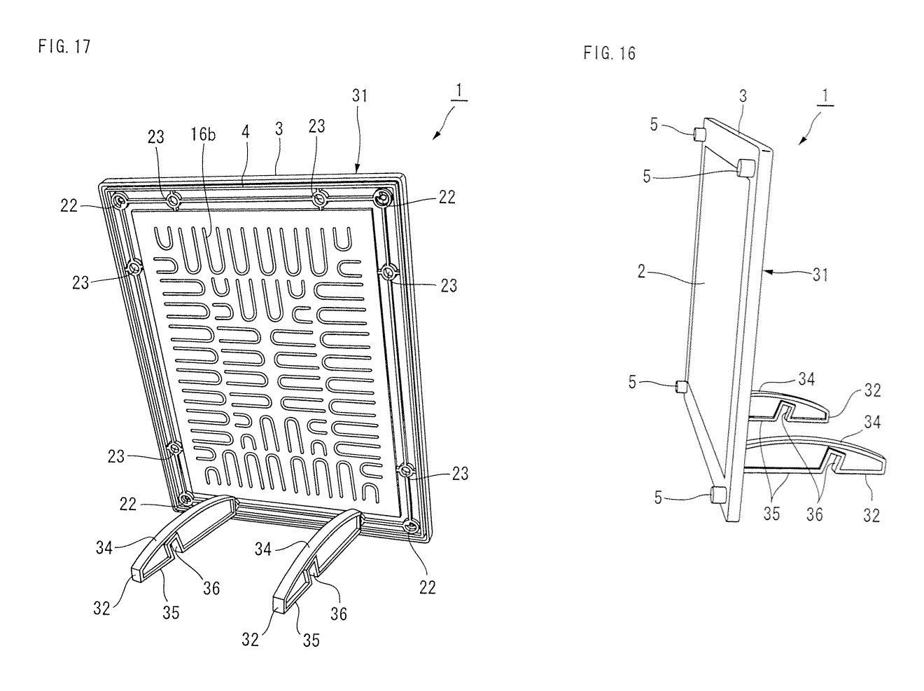

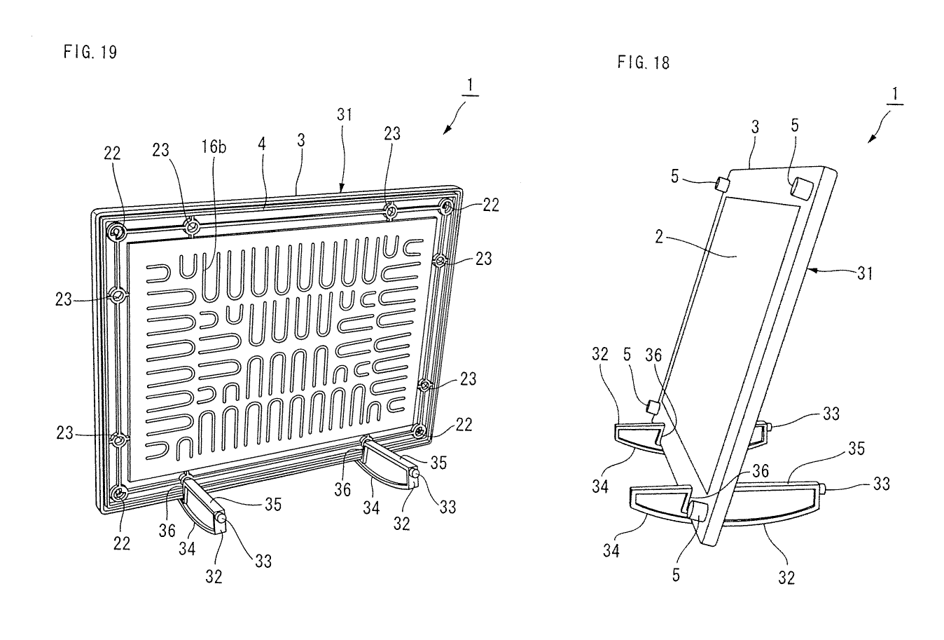

Hence, the stand 32 can switch between a first support state (see FIGS. 16 and 17) in which the assembly 31 is supported using the flat surface 35 as the bottom surface (placement surface) and a second support state (see FIGS. 18 and 19) in which the assembly 31 is supported using the convex surface 34 as the bottom surface (placement surface).

To cause the image display device 1 to display the stereoscopic image of the image sheet 14, first, the lens unit 3 is detached from the image sheet holding unit 4, and in this state, the image sheet 14 is fitted in the concave portion 16 of the image sheet holding unit 4 so as to be held. The lens unit 3 is placed on the obverse surface (front surface) of the image sheet holding unit 4 such that the image sheet 14 is sandwiched between the image sheet holding unit 4 and the lens unit 3. At this time, the image printed surface 14a of the image sheet 14 faces the lenticular lens 2.

The fixing pins 5 are inserted from the front side into the through holes 8 of the lens unit 3 and the through holes 21 of the image sheet holding unit 4. This insertion operation is performed by, for example, the user who grips the assembly 31 by one hand and holds the fixing pin 5 by the other hand. The insertion operation is performed such that the projecting portion 12 of the fixing pin 5 is inserted into the notch 8a of the through hole 8. At this time, the fixing pin 5 is inserted until the knob portion 13 abuts against the lens unit 3. In this state, the shaft portion 11 of the fixing pin 5 extends through the lens unit 3 and the image sheet holding unit 4, and the projecting portion 12 is located on the reverse surface side of the image sheet holding unit 4. As shown in FIG. 14, the fixing pin 5 is rotated by about 90° clockwise when viewed from the front side (the side of the lens unit 3) and set in the temporarily fixed state. The fixing pins 5 are inserted into the through holes 8 and 21 at the four portions, and all the fixing pins 5 are set in the temporarily fixed state.

In the temporarily fixed state, the user performs an adjustment operation while gripping the assembly 31 by both hands such that the stereoscopic image can correctly be viewed through the lenticular lens 2. This adjustment operation is performed by the user who translates the lens unit 3 in the vertical direction or horizontal direction relative to the image sheet holding unit 4 or slightly rotating the lens unit 3 about the axis in the forward/backward direction while viewing the stereoscopic image through the lens unit 3.

After the adjustment is done to correctly view the stereoscopic image, the user grips the assembly 31 by one hand and rotates all the fixing pins 5 up to the fastening position by the other hand (see FIG. 15). When the fixing pins 5 are rotated up to the fastening position, the lens unit 3 is fixed to the image sheet holding unit 4, and the lenticular lens 2 comes into tight contact with the image sheet 14.

To place the thus formed assembly 31 upright, the two stands 32 are attached to the lower end of the assembly 31, as shown in FIGS. 16 to 19. When the image sheet 14 that displays one type of stereoscopic image is used, the stands 32 are attached to the assembly 31 while causing the flat surfaces 35 to serve as the bottom surfaces (placement surfaces), thereby placing the assembly 31 upright such that it becomes long in the vertical direction, as shown in FIGS. 16 and 17. On the other hand, when a swing-type image sheet is used as the image sheet 14, the lower end of the assembly 31 is fitted in the notches 36 of the stands 32, and the stands 32 are attached to the assembly 31 while causing the convex surfaces 34 to serve as the bottom surfaces (placement surfaces), thereby placing the assembly 31 upright such that it becomes long in the horizontal direction, as shown in FIGS. 18 and 19. In this case, in a state in which the convex lenses 7 of the lenticular lens 2 extend in the lateral direction (for example, horizontal direction), the stands 32 are attached to the assembly 31 while setting the longitudinal direction of the stands 32 in the direction perpendicular to the convex lenses 7. In the state in which the convex surfaces 34 are located on the lower side, the assembly 31 can swing in the forward/backward direction. That is, the user swings the assembly 31 in the forward/backward direction and then moves the hand off. This allows him/her to appreciate, for example, a motion image printed on the swing-type image sheet 14 without touching the image display device 1.

As described above, to assemble the image display device 1, first, the image sheet holding unit 4 is caused to hold the image sheet 14, and after that, the lens unit 3 is overlaid on the image sheet holding unit 4. The fixing pins 5 are inserted into the through holes 8 and 21 of the lens unit 3 and the image sheet holding unit 4 and set in the temporarily fixed state.

In this state, the user relatively moves the lens unit 3 and the image sheet holding unit 4 by hand such that the image can correctly be viewed through the lenticular lens 2. In a state in which the image can correctly be viewed, the user sets the fixing pins 5 in the fastened state, thus completing the assembling operation of the image display device 1. For this reason, the user can align the lenticular lens 2 and the image while viewing the stereoscopic image, and easily fix the lens unit 3 to the image sheet holding unit 4 by operating the fixing pins 5 and setting them in the fastened state after the alignment is completed. Hence, according to this embodiment, it is possible to always correctly view the stereoscopic image through the lenticular lens 2 without any influence of tolerances at the time of manufacturing, although the image display device 1 can easily be assembled.

The engaging portion 22 according to this embodiment extends along the moving path of the projecting portion 12 that moves as the fixing pin 5 is rotated by the fastening operation. The interval between the engaging portion 22 and the surface of the image sheet holding unit 4 (the surface 17a of the frame portion 17) at the temporary fixing position of the engaging portion 22 is shorter than that at the fastening position. When the projecting portion 12 comes into contact with the temporary fixing position of the engaging portion 22, the fixing pin 5 is set in the temporarily fixed state. In addition, when the projecting portion 12 comes into contact with the fastening position of the engaging portion 22, the fixing pin 5 is set in the fastened state. It is therefore possible to fix the lens unit 3 and the image sheet holding unit 4 so that they cannot move relative to each other by the simple fastening operation of only rotating the fixing pin 5. Hence, according to this embodiment, it is possible to easily assemble the image display device 1 because the lens unit 3 can quickly be fixed to the image sheet holding unit 4 after completion of alignment between the lens unit 3 and the image sheet 14.

The image sheet 14 is fitted in the concave portion 16 formed in the image sheet holding unit 4 and thus held by the image sheet holding unit 4. The bottom portion of the concave portion 16 is provided with a number of cantilever spring pieces 18. The projections 19 projecting from the bottom surface of the concave portion 16 into the concave portion 16 are provided on the spring pieces 18 on the obverse surface side of the image sheet holding unit 4. For this reason, the image sheet 14 can be pressed from the rear surface side by the spring force of the spring pieces 18 and pressed against the lenticular lens 2. Hence, according to this embodiment, it is possible to more clearly view the stereoscopic image through the lenticular lens 2.

As shown in FIG. 1, the projections 19 are arranged at positions facing the four corners of each piece 15 of the jigsaw puzzle. For this reason, the spring forces of the spring pieces 18 are almost uniformly applied to the pieces 15. It is therefore possible to view a clear stereoscopic image through the lenticular lens 2 although the image of the image sheet 14 is divided into the pieces 15.

The image display device 1 includes the stand. 32 that can switch between the first support state in which the angle of the assembly 31 viewed from a side is kept constant and the second support state in which the assembly 31 can swing in the forward/backward direction. Hence, when the stand 32 is attached in the second support state, the image display device 1 can use the swing-type image sheet 14. That is, the user swings the image display device 1 in the forward/backward direction and then moves the hand off. The image display device 1 then continually swings, and the user can appreciate, for example, a motion image without touching the image display device 1.

The image display device 1 displays the image sheet 14 formed from a jigsaw puzzle and can therefore give the user the pleasure of completing the jigsaw puzzle and the pleasure of viewing the stereoscopic image after the jigsaw puzzle is completed. Note that the image sheet used in the image display device according to the present invention is not limited to the jigsaw puzzle and may be formed from one sheet on which a stereoscopic image is printed.

What is claimed is:

1. An image display device comprising:
an image sheet holding unit that holds an image sheet including an image printed surface on which an image is printed in a state in which the image printed surface is located on an obverse surface side;
a lens unit that includes a lenticular lens facing the image printed surface of the image sheet and is overlaid on the image sheet holding unit in a state in which the image sheet is sandwiched between the image sheet holding unit and the lens unit; and
a fixing pin that extends through the image sheet holding unit and the lens unit in a state in which the lens unit is overlaid on the image sheet holding unit,
wherein the fixing pin is configured to be able to switch between a temporarily fixed state in which the lens unit can move in a direction along the image printed surface relative to the image sheet holding unit and a fastened state in which movement of the lens unit relative to the image sheet holding unit is prevented, and the image sheet is pressed and sandwiched between the lens unit and the image sheet holding unit.

2. The image display device according to claim 1, further comprising a first through hole and a second through hole that are formed in the lens unit and the image sheet holding unit, respectively, and receive the fixing pin,
wherein the fixing pin includes a shaft portion, a projecting portion provided at one end of the shaft portion to project in a direction perpendicular to an axial direction of the shaft portion, and a knob portion provided at the other end of the shaft portion,
the image sheet holding unit includes an engaging portion that is provided around the second through hole on a reverse surface of the image sheet holding unit and comes into contact with the projecting portion of the fixing pin whose shaft portion extends through the first through hole and the second through hole,
the engaging portion extends along a moving path of the projecting portion that moves as the fixing pin rotates about the shaft portion, and
a thickness of the image sheet holding unit at a fastening position of the engaging portion is larger than a thickness of the image sheet holding unit at a temporary fixing position of the engaging portion, when the projecting portion comes into contact with the temporary fixing position of the engaging portion, the fixing pin is set in the temporarily fixed state, and when the projecting portion comes into contact with the fastening position of the engaging portion, the fixing pin is set in the fastened state.

3. The image display device according to claim 2, wherein
the knob portion has a diameter larger than that of the shaft portion, and
an interval between the knob portion and the projecting portion via the shaft portion equals a sum of a thickness of the lens unit and a thickness of the image sheet holding unit at the fastening position of the engaging portion.

4. The image display device according to claim 1, wherein
the image sheet holding unit includes a concave portion in which the image sheet is fitted, a plurality of spring pieces provided on a bottom portion of the concave portion, and a plurality of projections provided on the plurality of spring pieces on an obverse surface side of the image sheet holding unit, and
each of the plurality of spring pieces comprises a cantilever spring having one end connected to the bottom portion and the other end formed as a free end.

5. The image display device according to claim 4, wherein
the image sheet comprises a jigsaw puzzle formed from a plurality of pieces, and
at least one of the plurality of projections is provided in correspondence with each of the plurality of pieces.

6. The image display device according to claim 5, wherein the plurality of projections are arranged at positions corresponding to four corners of each of the plurality of pieces.

7. The image display device according to claim 1, further comprising a stand that includes a convex surface having an arc extending in a longitudinal direction thereof, and supports an assembly formed by assembling the image sheet holding unit and the lens unit,
wherein the image printed on the image sheet changes a pattern when an angle of view through the lenticular lens is changed,
the lenticular lens includes a plurality of convex lenses arrayed in parallel to each other, and
in a state in which the plurality of convex lenses extend in a lateral direction, and the assembly is placed upright, the stand is attached to the assembly while setting the longitudinal direction of the stand in a direction perpendicular to the plurality of convex lenses and causing the convex surface to serve as a bottom surface.

8. The image display device according to claim 7, wherein the stand is attachable to and detachable from the assembly, further includes a flat surface, and is attached to the assembly while causing the flat surface to serve as the bottom surface.

9. The image display device according to claim 1, wherein the image sheet comprises a jigsaw puzzle.
